(19) United States
(12) Patent Application Publication
(10) Pub. No.: US 2014/0092590 A1
(43) Pub. Date: Apr. 3, 2014

(54) LED FLASHLIGHT

(71) Applicant: Rambus Delaware LLC, Brecksville, OH (US)

(72) Inventors: Jeffery R. Parker, Richfield, OH (US); Kieran F. Drain, Aurora, OH (US); Fumitomo Hide, San Jose, CA (US); Gregg M Podojil, Brecksville, OH (US)

(73) Assignee: Rambus Delaware LLC, Brecksville, OH (US)

(21) Appl. No.: 14/032,598

(22) Filed: Sep. 20, 2013

Related U.S. Application Data
(60) Provisional application No. 61/740,718, filed on Dec. 21, 2012.
(60) Provisional application No. 61/708,360, filed on Oct. 1, 2012.

(51) Int. Cl. F21L 4/02

(52) U.S. Cl. CPC F21L 4/02
USPC 362/184

(57) ABSTRACT

A flashlight includes first and second solid-state light sources, a collimating optical element, and a light guide. Light output by the first light source interacts with the collimating optical element to output a light from the flashlight along an optical axis of the collimating optical element. The light guide includes an outer major surface, a first end, a second end, a longitudinal axis extending between the first end and the second end, and a light input edge at the first end. Light from the second light source is input to the light guide at the light input edge and propagates in the light guide by total internal reflection. The light guide additionally includes light extracting elements to extract light from the light guide with a radial component relative to the longitudinal axis and the optical axis.

### RELATED APPLICATION DATA

This application claims the benefit of U.S. Provisional Patent Application No. 61/708,360 filed Oct. 1, 2012 and U.S. Provisional Patent Application No. 61/740,718 filed Dec. 21, 2012, the disclosures of which are herein incorporated by reference in their entireties.

### BACKGROUND

Portable lighting devices, such as flashlights, are typically arranged to output a beam of light. Sometimes, however, a user is interested in illuminating an area wider than the beam. Lanterns are available, but there remains a need for a convenient form factor device that is capable of outputting a beam of light when desired and outputting more omni-directional light when desired.

### BRIEF DESCRIPTION OF THE DRAWINGS

FIG. 1 is a perspective view of an exemplary LED flashlight.

FIG. 2 is a side view of another exemplary LED flashlight when the LED flashlight is in an upright orientation and positioned on a supporting surface.

FIG. 3 is an exploded side view of an embodiment of the LED flashlight of FIG. 2.

FIG. 4 is an enlarged side view of an optical element for the embodiment of the LED flashlight of FIG. 3.

FIG. 5 is an exploded side view of another embodiment of the LED flashlight of FIG. 2.

FIG. 6 is an exploded side view of another embodiment of the LED flashlight of FIG. 2.

FIG. 7 is a cross sectional view of operative components of another exemplary LED flashlight in a first lighting state.

FIG. 8 is a cross sectional view of the operative components of the LED flashlight of FIG. 7 in a second lighting state.

### DESCRIPTION

Embodiments will now be described with reference to the drawings, wherein like reference numerals are used to refer to like elements throughout. The figures are not necessarily to scale. Features that are described and/or illustrated with respect to one embodiment may be used in the same way or in a similar way in one or more other embodiments and/or in combination with or instead of the features of the other embodiments. In this disclosure, angles of incidence, reflection, and refraction and output angles are measured relative to the normal to the surface.

A flashlight includes a first solid-state light source and a collimating optical element. Light output by the first solid-state light source is incident on the collimating optical element and light is output from the flashlight along an optical axis of the collimating optical element. The flashlight includes a second solid-state light source and an elongate light guide. The light guide includes an outer major surface, a first end, a second end, and a light input edge at the first end. There is a longitudinal axis extending between the first end and the second end. Light from the second solid-state light source is input to the light guide at the light input edge and propagates in the light guide by total internal reflection at the outer major surface. The light guide additionally includes light extracting elements to extract light from the light guide with a radial component relative to the longitudinal axis. In one embodiment, the light guide is a hollow body and additionally includes an inner major surface, and the light from the second solid-state light source propagates in the light guide by total internal reflection at the outer major surface and the inner major surface.

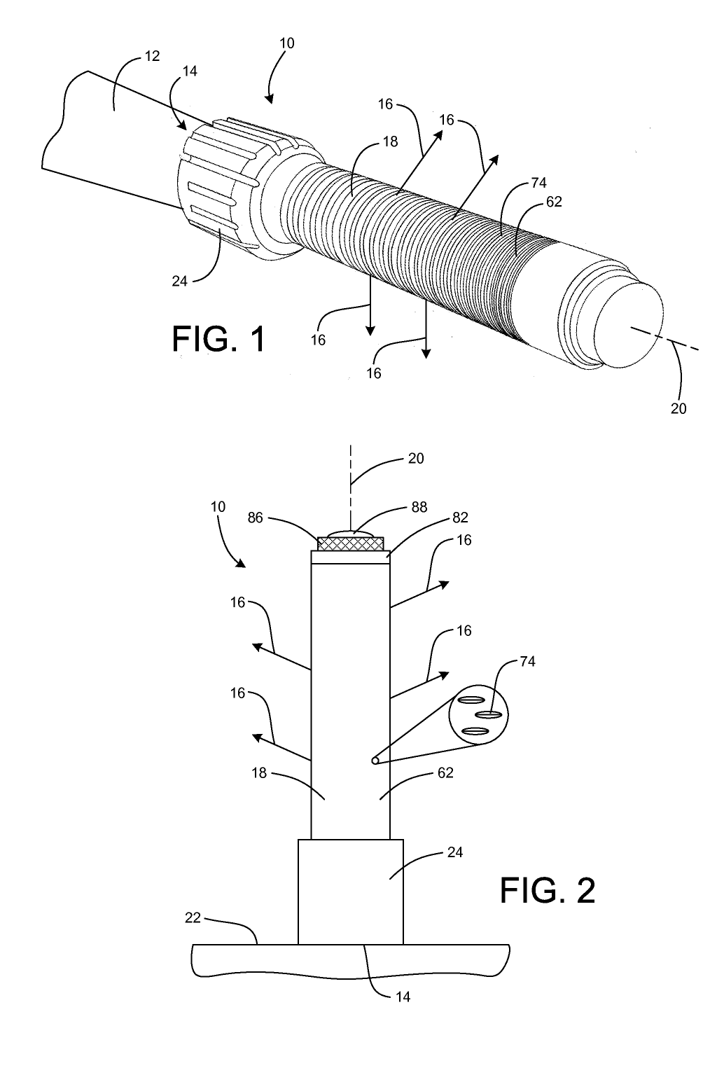

With initial reference to FIG. 1, illustrated is an LED flashlight 10. The flashlight 10 emits light 12 from a front end 14 of the flashlight 10 to illuminate surfaces and objects at which a user directs the light 12. The flashlight 10 also emits light (represented by arrows 16) from a handle 18. The light 16 emitted from the handle 18 is emitted from the handle 18 with a large radial vector component relative to a longitudinal axis 20 to illuminate areas surrounding the flashlight 10 akin to the way a lantern provides general illumination.

With additional reference to FIG. 2, a flashlight 10 is shown in an upright orientation. As used herein, the term upright orientation refers to when the flashlight 10 is positioned so that a longitudinal axis 20 of the flashlight is in a vertical orientation. In one embodiment, the flashlight 10 is considered to be in the upright orientation if the longitudinal axis 20 is within a threshold angle relative to vertical, such as about five degrees. In the exemplary illustration of FIG. 2, the flashlight 10 is placed on a surface 22 such that the flashlight 10 is supported by its front end 14.

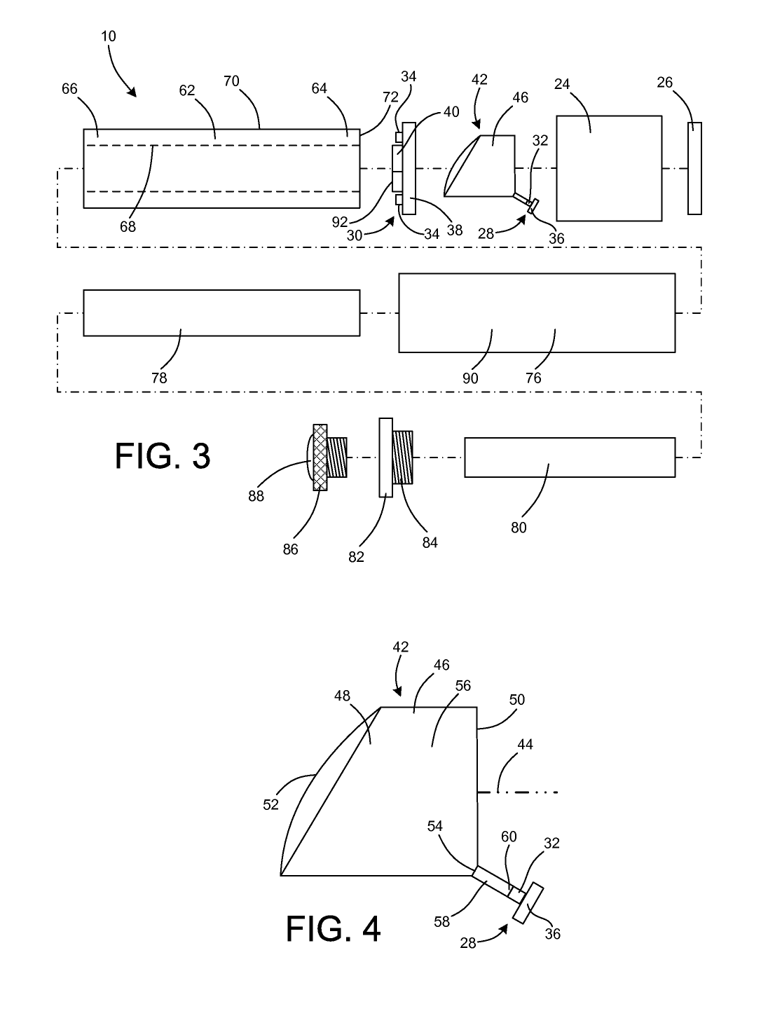

With additional reference to FIG. 3, an exploded view of an exemplary embodiment of the flashlight 10 is shown. Although FIGS. 2 and 3 are side views, the components of the flashlight 10 are three dimensional objects. Many of the objects have an inner surface such that their shape, in cross-section, is annular. In other embodiments, the components have different cross-sectional profiles.

In the illustrated embodiment, the flashlight 10 includes a front end housing 24. The housing 24 is generally cylindrical and configured as a hollow body that is open at both ends, including the front end 14. In one embodiment, the housing 24 is made from heat conductive material to dissipate heat generated by the light sources (discussed below). At the opening at the front end 14, the housing 24 may retain a cover 26. The light 12 is output through the cover 26. In one embodiment, the cover 26 is transparent and serves a protective shield for the flashlight 10 that does not significantly alter optical characteristics of the light 12. In other embodiments, the cover 26 serves as an optical component. For instance, the cover 26 may be shaped as a lens (e.g., to collimate or focus light) or the cover 26 may include color attenuating material to serve as a color filter.

In an internal volume of the housing 24, the housing 24 retains a first light source 28 and a second light source 30. The first light source 28 generates light for the light 12. The second light source 30 generates light for the light 16 that is emitted from the handle 18.

The first light source 28 is embodied as one or more solid-state light emitters 32. Similarly, the second light source 30 is embodied as one or more solid-state light emitters 34. Exemplary solid-state light emitters 32, 34 include devices such as LEDs and organic LEDs (OLEDs). In an embodiment where the solid-state light emitters 32, 34 are LEDs, the LEDs may be top-fire LEDs or side-fire LEDs, and may be broad spectrum LEDs (e.g., white light emitters) or LEDs that emit light of a desired color or spectrum (e.g., red light, green light, blue light, or ultraviolet light), or a mixture of broad-spectrum LEDs and LEDs that emit narrow-band light of a desired color. In one embodiment, one or both of the light sources 28, 30 include plural light emitters 32, 34 of different colors (e.g., red, green and blue) that are independently controlled to generate light in a desired color for the light 12 or the light 16 emitted from the handle 18.

In some embodiments, the solid-state light emitters 32, 34 generate light having the same nominal spectrum. In other embodiments, the solid-state light emitters 32, 34 generate light that differs in spectrum. For example, the first light source 28 and the second light source 30 may output white light of different color temperatures. In an exemplary embodiment, the color temperature of the light source 28 is cooler than the color temperature of the second light source 30.

Each light source 28, 30 includes structural components to respectively retain the light emitters 32, 34. In one embodiment, the light emitters 32, 34 are respectively mounted to a first printed circuit board (PCB) 36 and a second PCB 38. Although not shown, electrical conductors may interconnect the first and second PCBs 36, 38 for operation of the flashlight 10. Plural light emitters 34 may be mounted on the second PCB 38 in an arrangement to coordinate with a light input edge of a light guide (discussed below). The flashlight 10 may additionally include circuitry 40 for controlling and driving the light emitters 32, 34. In the illustrated embodiment, the circuitry 40 is mounted to the PCB 38. The PCBs 36, 38 may be thermally conductive so as to transfer heat generated by the light emitters 32, 34 to the housing 24 or another heat sink element.

To produce the light 12 from the light that is output by the first light source 28, the flashlight includes a collimating optical element 42. Light output by the first light source 28 is incident on the collimating optical element 42 and the light 12 is output from the flashlight 10 along an optical axis 44 of the collimating optical element 42. In one embodiment, the optical axis 44 is parallel to or coincident with the longitudinal axis 20.

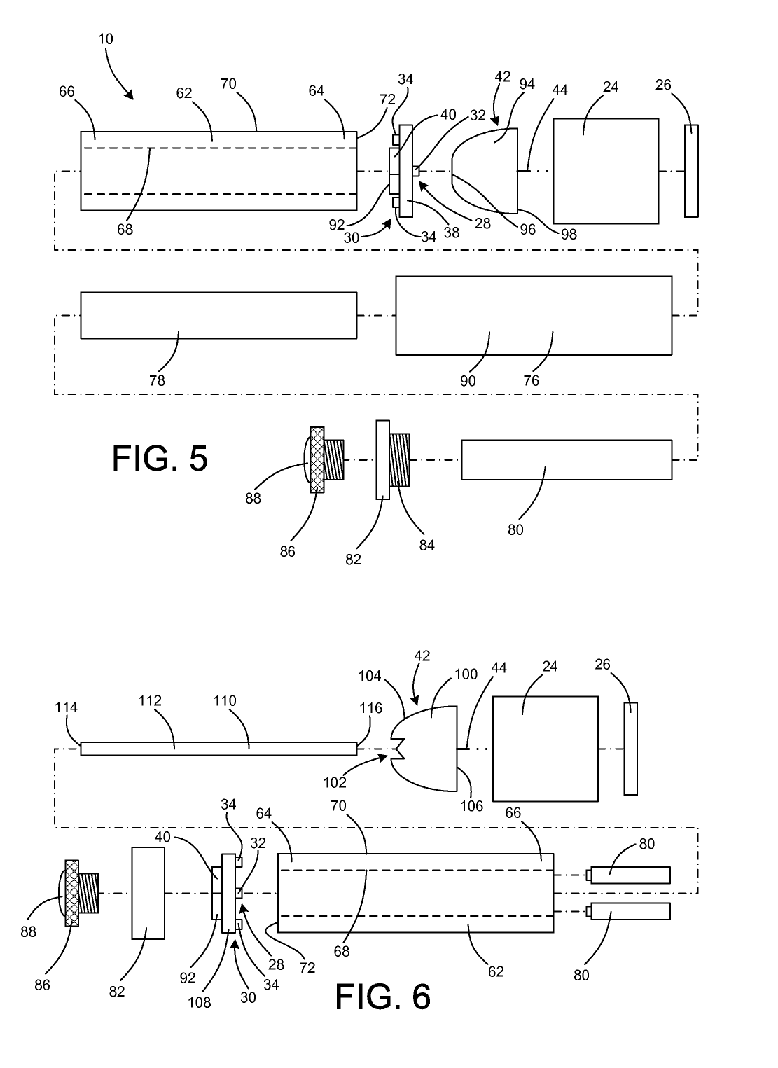

In the embodiment of FIG. 3, the collimating optical element 42 is an internal collecting reflector 46. A suitable internal collecting reflector 46 is described in detail in U.S. Patent Application Publication No. 2011/0116284 and, for the sake of brevity, will not be described in great detail in this disclosure. With additional reference to FIG. 4, the internal collecting reflector 46 includes a solid transparent optical element 48 having a light output surface 50 and, opposite the light output surface 50, a reflective surface 52 shaped to create an internal reflection effect. In this example, the light output surface 50 is planar and is perpendicular to the optical axis 44 of the collimating optical element 42. The first light source 28 is adjacent the light output surface 50 to direct light towards the reflective surface 52 and the light from the first light source 28 is reflected by the reflective surface 52 to form the light 12 that exits the solid optical element 48 through the light output surface 50. The light from the first light source 28 may be input to the optical element 48 through a light input surface 54 located at an intersection between the light output surface 50 and a cylindrical outer side surface 56. The cylindrical outer surface 56 extends between and spaces apart the light output surface 50 and the reflective surface 52. The light input surface 54 can be a facet at an angle relative to the light output surface 50 and cylindrical outer side surface 56. The reflective surface 52 is curved to collimate light that is reflected by the reflective surface 52. The curve is convex to the exterior of the solid optical element 48 (i.e., the reflective surface 52 bows outward). Also, the cylindrical outer surface 56 is longer adjacent to and closer to the first light source 28 than at a portion of the solid optical element 48 opposite to and further from the first light source 28. Therefore, the reflective surface 52, as a whole, is tilted relative to the optical axis 44 of the solid optical element 48. The central axis of the solid angle of the light input to the solid optical element 48 is also tilted relative to the optical axis and coordinated with the arrangement of the reflective surface 52. The orientation and position of the light input into the solid optical element 48 is selected so that the central axis of the input light intersects the reflective surface 52 near a center of the reflective surface 52 to maximize the amount of light incident on the reflective surface 52. An angle between the central axis and the optical axis 44 should be kept as small as possible to keep the optical element 48 small in size. On the other hand, the first light source 28 is positioned near the perimeter of the light output surface 50 to prevent the first light source 28 from obstructing the light output from the light output surface 50. The light is reflected by a reflective coating that is applied to the reflective surface 52.

Additionally, the collimating optical element 42 includes a light pipe 58 extending from the light input surface 54 at the edge of the light output surface 50. The light emitter 32 of the first light source 28 is mounted at a distal end 60 of the light pipe 58, the distal end 60 being remote from the solid optical element 48. The light pipe 58 mixes light from the light emitter 32 and narrows the cone angle of the light emitted from the light emitter 32 and entering the solid optical element 48 (compared to what the cone angle would be if the light emitted from the light emitter 32 propagated in free space before entering the solid optical element 48). In other examples, the light pipe 58 is omitted and the first light source 28 is directly mounted or optically coupled to the light input surface 54. An advantage of using the light pipe 58 is that the length of the light pipe laterally offsets the PCB 36 on which the light emitter 32 is attached from the light path of the light output from the light output surface 50. However, if the PCB 36 is sufficiently small, it is possible to omit the light pipe 58.

As shown in FIGS. 1 and 2, the light 16 is output from the handle 18. For this purpose, the handle 18 includes a light guide 62. As will be described, light generated by the second light source 30 is input to the light guide 62, propagates in the light guide 62, and is extracted from the light guide 62 as the light 16.

The light guide 62 is made from, for example, polycarbonate, poly(methyl-methacrylate) (PMMA), glass, or other appropriate material. The light guide 62 may also be a multi-layer light guide having two or more layers that may differ in refractive index. In the illustrated embodiments, the light guide 62 is configured as hollow cylinder that is open at both ends. The light guide 62 extends along the longitudinal axis 20 (FIG. 2) between a first end 64 adjacent the light source 30 and a second end 66. In one embodiment, the light guide 62 is hollow and includes an inner major surface 68 (shown in dashed lines in FIG. 3 to shown a hidden surface) and an outer major surface 70 opposite the inner major surface 68. The major surfaces 68, 70 extend along the longitudinal axis 20 between the first end 64 and the second end 66. In other embodiments, the light guide 62 is frustoconical, has an hourglass shape, or is configured with another suitable shape. In another embodiment, the light guide 62 is solid, having only the outer major surface 70. In yet another embodiment, the light guide 62 is configured as a segment of a cylinder.

The length and circumference dimensions of each of the major surfaces 68, 70 are greater, typically ten or more times greater, than the thickness of the light guide 62. The thickness is the dimension of the light guide 62 in a direction orthogonal to the major surfaces 68, 70. The thickness of the light guide 62 may be, for example, about 0.1 millimeters (mm) to about 10 mm. In one embodiment, the light guide 62 is structurally strong enough to function as the handle 18 of the flashlight 10 when handled by a user.

An edge at the first end 64 of the light guide 62 provides a light input edge 72 through which light from light source 30 is input to the light guide 62. Each light emitter 34 of the light source 30 is configured to edge light the light guide 62 such that light from the light source 30 enters the light input edge 72 and propagates along the light guide 62 by total internal reflection at the inner major surface 68 and the outer major surface 70. In one embodiment, the first end 64 of the light guide 62 is retained adjacent to the light source 30 by the front end housing 24. In the embodiment shown in FIG. 3, the first end 64 of the light guide 62 is proximal the collimating optical element 42 and the direction of light propagation in the light guide 62 is away from the collimating optical element 64.

The light guide 62 includes light extracting elements 74 (FIGS. 1 and 2) in, on, or beneath at least one of the major surfaces 68, 70. Light extracting elements that are in, on, or beneath the major surface 68, 70 will be referred to as being “at” the major surface. Each light extracting element 74 functions to disrupt the total internal reflection of the propagating light that is incident on the light extracting element 74. In one embodiment, the light extracting elements 74 reflect light toward the opposing major surface so that the light exits the light guide 62 through the opposing major surface. Alternatively, the light extracting elements 74 transmit light through the light extracting elements and out of the major surface of the light guide 62 having the light extracting elements. In another embodiment, both types of light extracting elements 74 are present. In yet another embodiment, the light extracting elements 74 reflect some of the light and refract the remainder of the light incident thereon. Therefore, the light extracting elements 74 are configured to extract light from the light guide 62 through one or both of the major surfaces 68, 70.

Exemplary light extracting elements 74 include light-scattering elements, which are typically features of indistinct shape or surface texture, such as printed features, ink jet printed features, selectively-deposited features, chemically etched features, laser etched features, and so forth. Other exemplary light extracting elements include features of well-defined shape, such as V-grooves and lenticular grooves. For example, the light extracting elements 74 depicted in FIG. 1 are of lenticular grooves at the outer major surface 70. The lenticular grooves or V-grooves may circumscribe the cylindrical light guide 62.

Another exemplary type of light extracting element of well-defined shape includes light extracting elements that are small relative to the linear dimensions of the major surfaces (e.g., major surfaces 68, 70), which are referred to herein as micro-optical elements. The light extracting elements 74 depicted in the exemplary embodiment of FIG. 2 are micro-optical elements. The smaller of the length and width of a micro-optical element is less than one-tenth of the longer of the length and width (or circumference) of the light guide (e.g., light guide 62) and the larger of the length and width of the micro-optical element is less than one-half of the smaller of the length and width (or circumference) of the light guide. The length and width of the micro-optical element is measured in a plane parallel to the major surface of the light guide for planar light guides or along a surface contour for non-planar light guides (e.g., light guide 62).

The micro-optical elements are configured to extract light in a defined intensity profile (e.g., a uniform intensity profile) and in a defined light ray angle distribution from one or both of the major surfaces 68, 70. In this disclosure, intensity profile refers to the variation of intensity with position within a light-emitting region (such as the major surface or a light output region of the major surface). The term light ray angle distribution is used to describe the variation of the intensity of light with ray angle (typically a solid angle) over a defined range of light ray angles. In an example in which the light is emitted from an edge-lit light guide, the light ray angles can range from −90° to +90° relative to the normal to the major surface.

Micro-optical elements are shaped to predictably reflect or refract light. However, one or more of the surfaces of the micro-optical elements may be modified, such as roughened, to produce a secondary effect on light output. Exemplary micro-optical elements are described in U.S. Pat. No. 6,752,505 and, for the sake of brevity, are not described in detail in this disclosure. The micro-optical elements may vary in one or more of size, shape, depth or height, density, orientation, slope angle, or index of refraction such that a desired light output from the light guide 62 is achieved over the corresponding major surface 68, 70.

Light guides having light-extracting elements 74 are typically formed by a process such as injection molding. The light-extracting elements 74 are typically defined in a shim or insert by a process such as diamond machining, laser etching, laser micromachining, chemical etching, or photolithography. The shim or insert is then used for injection molding light guides. Alternatively, any of the above-mentioned processes may be used to define the light-extracting elements 74 in a master that is used to make the shim or insert. In other embodiments, light guides without light-extracting elements 74 are typically formed by a process such as injection molding or extruding, and the light-extracting elements 74 are subsequently formed on one or both of the major surfaces 68, 70 by a process such as stamping, embossing, laser etching, or another suitable process. Light-extracting elements 74 may also be produced by depositing elements of curable material on the major surfaces 68, 70 of the light guide 62 and curing the deposited material using heat, UV-light, or other radiation. The curable material can be deposited by a process such as printing, ink jet printing, screen printing, or another suitable process. Alternatively, the light-extracting elements 74 may be inside the light guide between the major surfaces 68, 70 (e.g., the light-extracting elements 74 may be light redirecting particles and/or voids disposed within the light guide).

In one embodiment, the flashlight 10 includes a sheath 76 around the light guide 62. The sheath 76 may serve to protect the light guide 62. In some embodiments, the sheath 76 is transparent. In other embodiments, the sheath 76 includes color attenuating material to serve as a color filter. Other possible functions of the sheath 76 are described below. In the embodiment illustrated in FIG. 3, the sheath 76 is concentric with the light guide 62 and juxtaposed with the outer major surface 70. In embodiments where the sheath 76 is present, the sheath 76 is part of the handle 18 and adds structural rigidity to the handle 18.

In one embodiment, the flashlight includes a reflector 78 located inside the light guide 62 and juxtaposed with the inner major surface 68 of the light guide 62. Light exiting the light guide 62 through the inner major surface 68 is reflected by the reflector 78 back into the light guide 62 through the inner major surface 68. The reflected light travels through the light guide 62 and exits the light guide 62 through the outer major surface 70 as part of the light 16. The rest of the light 16 is light that exits the light guide directly through the outer major surface 70.

The flashlight 10 includes a power source 80 to supply electric power to the circuitry 40 and the first and second light sources 28, 30. Typically, the power source 80 is a replaceable battery or a rechargeable battery. In one embodiment, the power source 80 is disposed in the hollow space of the light guide 62.

In the illustrated embodiments, a distal end housing 82 is present at the second end 66 of the light guide 62. The distal end housing 82 may be secured to the light guide 62. In one embodiment, the distal end housing 82 has a threaded portion 84 that mateably screws into threads (not shown) formed at the inner major surface 68 of the light guide 62 at the second end 66 of the light guide 62. An end cap 86 is present and removeably secures (e.g., with a threaded connection) to the distal end housing 82. The end cap 86 is removable to allow for replacement of the power source 80.

The flashlight 10 includes a user interface 88. In the illustrated embodiment, the user interface 88 is a switch, such as the illustrated push button switch located on the end cap 86. The user interface 88 may be located on other components, such as the distal end housing 82, the light guide 62 or the front end housing 24. Also the user interface 88 may take other forms. For example, the user interface 88 may include plural buttons or switches, touch interfaces, membrane switches, etc. Another exemplary user interface 88 includes a rotary switch assembly that is operated by rotating the front end housing 24 relative to the handle 62. The rotary switch may be used to control the color of light output by the flashlight 10 by selectively controlling different color light emitters 32, 34 in the light sources 28, 30.

The operation of the flashlight 10 is controlled using the user interface 88. For example, the user may select one of plural operational modes with the user interface 88. In one embodiment, the operation modes of the flashlight 10 include a first mode in which the light 12 is output from the front end 14 (e.g., the first light source 28 is on) and the light 16 is not output from the light guide 62 (e.g., the second light source 30 is off); a second mode in which the light 16 is output from the light guide 62 (e.g., the second light source 30 is on) and the light 12 is not output from the front end 14 (e.g., the first light source 28 is off); a third mode in which both the light 12 and light 16 from the light guide 62 are output (e.g., the first and second light sources 28, 30 are on); and a fourth mode in which neither the light 12 nor the light 16 from the light guide 62 is output (e.g., the first and second light sources 28, 30 are off). In the embodiment where the user interface 88 is a button switch, the user may cycle through these operational modes, or any other operational modes of the flashlight 10, by successively pressing the button switch.

Other forms of user input or changing the operational mode of the flashlight 10 are possible. In one exemplary embodiment, the sheath 76 includes a sensor 90 that detects grasping of the sheath 76 with a hand of a user. Exemplary sensors 90 for this purpose include a resistive or capacitive touch-sensitive sensor similar to touch input sensors used to implement touch-screen functionality with an electronic device that includes a display. This type of sensor, however, need not detect location of touch when used as part of the flashlight 10. Rather, the sensor need only detect the presence of the hand of the user. If the user's hand is touching the sheath, the circuitry 40 (functioning as control electronics for the flashlight) controls a light output mode of the flashlight in accordance with the touching. For example, upon detection of grasping of the sheath, the circuitry 40 may turn on the light source 28 to output the light 12 from the flashlight 10.

In another embodiment, the sensor 90 of the sheath 76 detects heart rate of the user. For this purpose, the sensor 90 may be configured as the touch sensor described above or may include spaced-apart electrodes. In response to detection of the heart rate, the circuitry 40 changes a light output mode of the flashlight in accordance with detected heart rate. For instance, the flashlight 10 may pulse light with each heart beat or may change the color of light output (e.g., blue or green light for a heart rate below a first predetermined threshold, red light for a heart rate above a second predetermined threshold, and amber light for a heart rate between the first and second predetermined thresholds).

Another type of sensor that may be included in the flashlight 10 is a sensor 92 that detects orientation of the flashlight 10. The sensor 92 may be implemented using one or more accelerometers or a gyro sensor. In response to detecting that the flashlight is in an upright orientation (defined above) with the sensor 92, the circuitry 40 may change a light output mode of the flashlight. For instance, if the light 12 were on and it is detected that the flashlight 10 moves to the upright orientation with no further motion (e.g., indicative that the flashlight 10 is resting with the front end 14 on the stationary surface 22), then the light 12 may be turned off and the second light source 30 may be turned on to output the light 16 from the handle 18. In another embodiment, a sensor may be located at the front end 14 to detect pressure on the front end 14, such as pressure resulting from the flashlight being in the upright orientation and the front end 14 resting on the surface 22. If pressure is detected in this manner, then the light 12 may be turned off (if on) and the second light source 30 may be turned on to output the light 16 from the handle 18. If it is detected that the flashlight 10 leaves the upright orientation, the operational mode may be changed back to output the light 12.

In one configuration of the circuitry 40, operational modes of the flashlight 10 will not change unless the flashlight 10 is already in use. In this manner, the flashlight 10 will not generate light without being desired by the user.

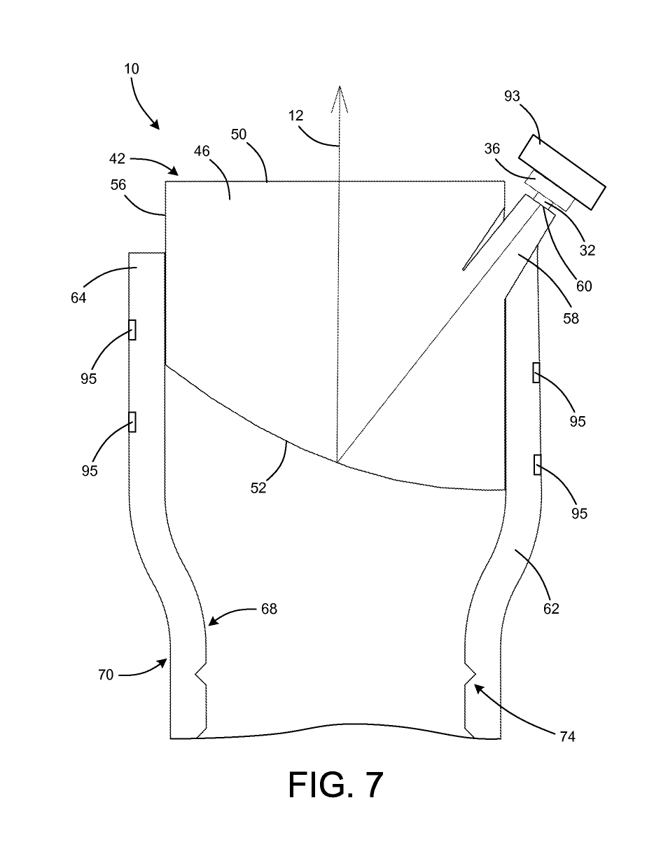

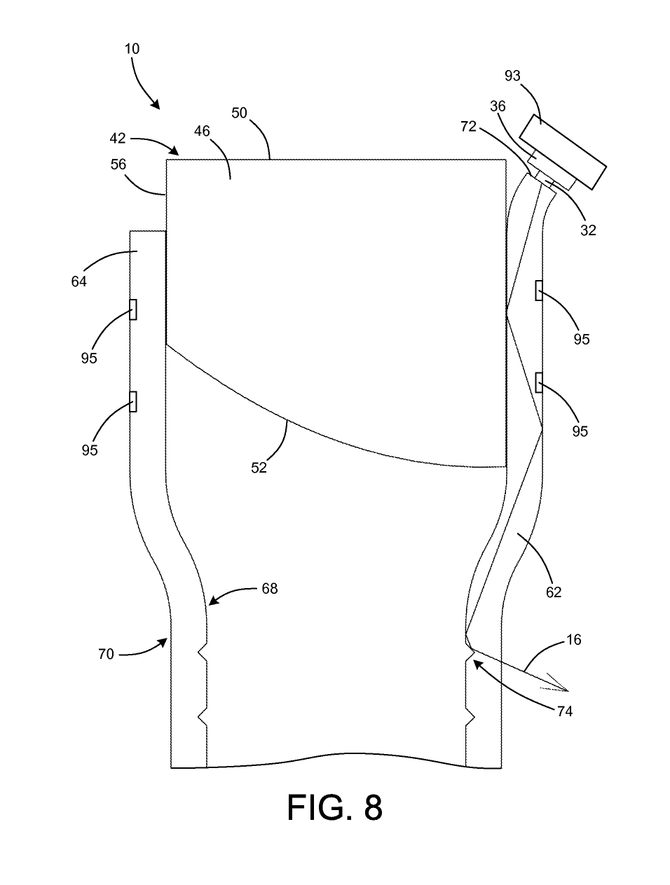

Another exemplary flashlight is illustrated in FIGS. 7 and 8. FIG. 7 shows the flashlight 10 in a first lighting state and FIG. 8 shows the flashlight 10 in a second lighting state. In this flashlight, a single light source 32 is used to light both the collimating optical element 42 and the light guide 62. For purposes of illustration, the full length of the exemplary light guide 62 is not shown.

The light source 32 is mounted to a PCB 36 which is mounted to a rotating member 93 that can be rotated to at least a first angular position and a second angular position. In the first lighting state, the rotating member 93 is in the first angular position where the light source is positioned to input light to the light pipe 58 of the collimating optical element 42, which in FIGS. 7 and 8 is embodied as an internal collecting reflector 56. In the second lighting state, the rotating member 93 is in the second angular position where the light source is positioned to input light to the light input edge 72 of the light guide 62. In the first lighting state, the light reflects from the reflective surface 52 and is output from the light output surface 50 of the collimating optical element. In the second lighting state, the light propagates in the light guide 62 by total internal reflection between the major surfaces 68, 70 and is extracted from the light guide by light extracting elements 74. The light guide may additionally have light redirecting features to spread the light in the circumferential directions before light is extracted. As shown in FIG. 7 the light pipe 58 is monolithic with the internal collecting reflector 56. In the example shown in FIGS. 7 and 8, the light guide 62, in cross section, is annular. In other examples, the light guide can be configured as a segment of a cylinder.

The light guide 62 of this embodiment is illuminated with light at a localized circumferential location (e.g., at the light input edge 72 adjacent the light source 32 when the light source 32 is in the second lighting state). Therefore, to achieve more uniform light distribution in the light guide 62 and more uniform light extraction from the light guide 62, the light guide 62 of this embodiment additionally includes light redirecting features (schematically shown in connection with reference numeral 95) to spread the light in circumferential directions.

With additional reference to FIG. 5, another embodiment of the flashlight is illustrated. Features that are the same as the flashlight of FIG. 3 will not be repeated. In the embodiment of FIG. 5, the collimating optical element 42 is a parabolic reflector 94. In this embodiment, the first light source 28 is mounted to the PCB 38 such that the emitter 32 is on the opposite side of the PCB 38 from the emitters 34 of the second light source 30. The parabolic reflector 94 is a hollow body with an opening at a proximal end 96 through which the light emitter 32 extends to introduce light into the internal volume of the reflector 94. The interior surfaces of the reflector are reflective and structurally arranged to collimate light output by the light emitter 32. A distal end 98 of the parabolic reflector 94 is open to allow the light 12 to travel in the direction of the optical axis 44 of the collimating optical element 42.

In the embodiment of FIG. 5, the flashlight 10 includes only one printed circuit board (the PCB 38) for mounting the light sources. Also, the first end 64 of the light guide 62 is proximal the collimating optical element 42 and the direction of light propagation in the light guide 62 is away from the collimating optical element 42. In one embodiment, the parabolic reflector 94 is moveable in the longitudinal direction relative to the light emitter 32 to change the focus of the light 12. In one embodiment, longitudinal movement of the parabolic reflector 94 is controlled by rotational movement of the front end housing 24.

With additional reference to FIG. 6, another embodiment of the flashlight is illustrated. Features that are the same as the flashlight of FIG. 3 will not be repeated. In the embodiment of FIG. 6, the collimating optical element 42 is a solid parabolic reflector 100. The solid parabolic reflector 100 is made of transparent material with an entrance feature 102 having reflective and refractive features to direct incident light toward parabolic side walls 104 of the solid parabolic reflector 100. The light reflects at the side walls 104 by total internal reflection or the side walls 104 are coated with a reflective material. The side walls 104 collimate the light into the light 12, which is output through an output surface 106.

In the embodiment of FIG. 6, a PCB 108 retains the light emitter 32 of the first light source 28 and the light emitters 34 of the second light source 30. The light emitters 32, 34 are located on the same side of the PCB 108. Also, the first end 64 of the light guide 62 having the light input edge 72 is distal the collimating optical element 42 and the direction of light propagation in the light guide 62 is toward the collimating optical element 42.

To transmit light from the light emitter 32 to the entrance feature 102 of the solid parabolic reflector 100, the flashlight 10 includes a light pipe 110 that extends between the light emitter 32 and the entrance feature 102. The light pipe 110 is a solid cylinder having an outer major surface 112 at which light from the light emitter 32 propagates by total internal reflection. Alternatively, the outer major surface 112 may be coated with a reflective material. Light from the light emitter 32 is input to the light pipe 110 at a light input end 114 adjacent the light emitter and is output from a light output end 116 adjacent the entrance feature 102 of the solid parabolic reflector 100.

In one embodiment, the solid parabolic reflector 100 is moveable in the longitudinal direction relative to the light output end 116 of the light pipe 110 to change the focus of the light 12. In one embodiment, longitudinal movement of the solid parabolic reflector 100 is controlled by rotational movement of the front end housing 24.

In this disclosure, the phrase “one of followed by a list is intended to mean the elements of the list in the alterative. For example, “one of A, B and C” means A or B or C. The phrase “at least one of followed by a list is intended to mean one or more of the elements of the list in the alterative. For example, “at least one of A, B and C” means A or B or C or (A and B) or (A and C) or (B and C) or (A and B and C).

What is claimed is:

1. A flashlight, comprising:
a first solid-state light source;
a collimating optical element, light output by the first solid-state light source being incident on the collimating optical element such that the light is output from the flashlight along an optical axis of the collimating optical element;
a second solid-state light source; and
an elongate light guide comprising an outer major surface, a first end, a second end, and a light input edge at the first end, wherein a longitudinal axis extends between the first end and the second end, light from the second solid-state light source input to the light guide at the light input edge and propagating in the light guide by total internal reflection, the light guide additionally comprising light extracting elements to extract light from the light guide with a radial component relative to the longitudinal axis.

2. The flashlight of claim 1, wherein the optical axis is parallel to the longitudinal axis.

3. The flashlight of claim 1, wherein the light guide is a solid body.

4. The flashlight of claim 1, wherein the light guide is a hollow body and additionally comprises an inner major surface, the light from the second solid-state light source propagating in the light guide by total internal reflection at the outer major surface and the inner major surface.

5. The flashlight of claim 4, wherein the light extracting elements are at at least one of the outer major surface and the inner major surface.

6. The flashlight of claim 4, additionally comprising a power source for the first and second solid-state light sources, the power source disposed within the hollow body of the light guide.

7. The flashlight of claim 1, wherein the first end of the light guide is closer to the collimating optical element than the second end of the light guide is to the collimating optical element.

8. The flashlight of claim 1, wherein the second end of the light guide is closer to the collimating optical element than the first end of the light guide is to the collimating optical element and the second solid-state light source is located at the first end of the light guide and the flashlight additionally comprises a light pipe to transmit light from the second solid-state light source to the collimating optical element.

9. The flashlight of claim 1, additionally comprising a sheath concentric with the light guide and juxtaposed with the outer major surface, and wherein a handle for the flashlight comprises the sheath.

10. The flashlight of claim 9, additionally comprising a sensor that is configured to output a signal when the sheath is grasped by a hand of a user, and the flashlight additionally comprises control electronics that controls light output modes of the flashlight in response to the signal.

11. The flashlight of claim 1, wherein the collimating optical element comprises a parabolic reflector.

12. The flashlight of claim 1, wherein the collimating optical element comprises an internal collecting reflector.

13. The flashlight of claim 12, wherein the internal collecting reflector comprises a solid transparent optical element comprising a light output surface and a curved reflective surface opposite the light output surface, wherein the first solid-state light source is adjacent an edge of the light output surface to direct light towards the reflective surface and the light from the light source is reflected by the reflective surface to form light that exits the solid optical element through the light output surface.

14. The flashlight of claim 13, wherein:
the collimating optical element additionally comprises a light pipe extending from the solid optical element adjacent an edge of the light output surface; and
the light source is mounted adjacent a distal end of the light pipe, remote from the solid optical element.

15. The flashlight of claim 1, additionally comprising a sensor that is configured to output a signal indicative of at least one of orientation and placement of the flashlight, and the flashlight additionally comprises control electronics that controls light output modes of the flashlight in response to the signal so that, upon detection of at least one of an upright orientation of the flashlight or placement of the flashlight on a surface in an upright orientation, the control electronics changes a light output mode of the flashlight.

16. The flashlight of claim 1, wherein at least one of the first solid-state light source or the second solid-state light source comprises light emitters of more than one color, and emission of each light emitter is selectively controlled.

17. The flashlight of claim 1, wherein the first and second solid-state light sources are selectively powered so that the flashlight has multiple light output modes.

18. The flashlight of claim 17, wherein the light output modes include:
output of light from the collimating optical element without output of light from the light guide;
output of light from the light guide without output of light from the collimating optical element;
output of light from the collimating optical element and light from the light guide; and
output of neither of the light from the collimating optical element nor light from the light guide.

19. A flashlight, comprising:
a solid-state light source;
an internal collecting reflector, light output by the solid-state light source being incident on the internal collecting reflector through a light pipe such that the light is output from the flashlight along an optical axis of the collimating optical element;
an elongate light guide comprising an outer major surface, a first end, a second end, and a light input edge at the first end, wherein a longitudinal axis extends between the first end and the second end, light from the solid-state light source input to the light guide at the light input edge and propagating in the light guide by total internal reflection, the light guide additionally comprising light extracting elements to extract light from the light guide with a radial component relative to the longitudinal axis; and
a rotating member on which the solid-state light source is mounted, the rotating member being configured to rotate between a first angular position at which the solid-state light source inputs light to the internal collecting reflector through the light pipe and a second angular position at which the solid-state light source inputs light to the light guide through the light input edge.

20. The flashlight of claim 19, wherein the light guide additionally comprises light redirecting features to spread the light in circumferential directions.

21. The flashlight of claim 19, wherein the light guide is a hollow body and additionally comprises an inner major surface, the light from the solid-state light source propagating in the light guide by total internal reflection at the outer major surface and the inner major surface.
